(19) United States
(12) Patent Application Publication
(10) Pub. No.: US 2022/0019980 A1
(43) Pub. Date: Jan. 20, 2022

(54) SYSTEMS AND METHODS FOR REMOTE MOBILE REFUELING

(71) Applicant: Colton Rogers, Auburn, WA (US)

(72) Inventor: Colton Rogers, Auburn, WA (US)

(21) Appl. No.: 16/928,941

(22) Filed: Jul. 14, 2020

(51) Int. Cl. G06Q 10/10; G06Q 20/14; G06F 16/9032; G06F 16/9038; G06F 3/0482

(52) U.S. Cl. CPC G06Q 10/1095; G06Q 20/145; G06F 3/0482; G06F 16/9038; G06F 16/9032

(57) ABSTRACT

Methods and systems for on-demand, remote fueling of vehicles can include a user device for displaying information to and receiving commands from a user, an operator device for displaying information to and receiving commands from a service provider, and a controller configured to communicate with any suitable number of user and operator devices to manage scheduling for service requests. The controller can receive a service request from a user device, the service request including request location and request timing information for a refueling operation, and can generate a service appointment for presentation to the service provider that includes a service location and service timing information based at least in part on the request location and request timing information. The controller can also communicate service information, to the user via the user device, when the service request has been completed.

### BACKGROUND

Personal vehicles remain a primary form of transportation for many if not most Americans for all manner of uses: work-related commuting, transporting family and particularly children, running errands and moving personal property, and transportation for pleasure. The virtual necessity of personal vehicles for transportation runs into several challenges in modern living in the face of increasing demands for efficiency and environmental considerations. Electric vehicles (EVs) are one category in which personal vehicles are evolving to meet modern demands. Commercially available EVs are highly efficient and can be charged from home, or at charging stations that have been placed throughout parking lots and parking garages across the country. However, EVs still have limited range on a charge, charge more slowly than internal-combustion vehicles, and are financially out of reach for most vehicle owners. Conversely, combustion vehicles are readily available, relatively inexpensive, and familiar; and there therefore likely here to stay for quite some time, even as cities become denser and people become more interconnected by technology. With that reality in mind, systemic improvements in the way that combustion vehicles are operated in order to reduce waste and fuel expenditure are of great interest.

### SUMMARY

Various techniques are described herein for implementing a system for on-demand vehicle refueling. According to various embodiments, a vehicle refueling system can include a user device, an operator device, and a controller that is network-connected to the devices. The user device can include a user display interface configured to display information to and receive commands from a user, and likewise the operator device can include an operator display interface configured to display information to and receive commands from a service provider. The controller can be configured with instructions to receive a service request from a user device, generate service appointments based on the information obtained from the service request(s), and communicate instructions to the service provider(s) via one or more operator devices. The service request can include a request location and request timing information for a refueling operation, and in response to receiving the service request, the controller can generate a service appointment for presentation to the service provider that includes a service location and service timing information based at least in part on the request location and request timing information obtained from the user request. Upon completion of a refueling operation, the controller can receive a service completion notification from the operator device and then communicate, to the user via the user device, that the service request has been completed. The service completion notification can include suitable service information for generating an invoice or for processing a payment by the user for the refueling operation, which can be processed in the background or can be relayed to the user for approval.

According to various embodiments of the present disclosure, systems for implementing on-demand vehicle refueling can further include one or more service provider or operator vehicles carrying auxiliary fuel tanks or electric charging stations and batteries for refueling or recharging user vehicles. The quantity of fuel or energy available for a refueling or recharging operation can be monitored by reporting from the service provider, which may be automated or manual, the controller can further generate instructions to the service provider to periodically resupply when the available quantity of fuel or energy falls below a threshold.

According to various embodiments of the present disclosure, a method for on-demand vehicle refueling can include receiving, by a computer system, a user request to refuel a user vehicle, selecting a service provider for conducting the refueling operation, and generating instructions for presentation to the service provider instructing the service provider to identify the user's vehicle and to conduct the refueling operation. The user request can include a user vehicle location and a requested time, and may include additional information useful for identifying the user vehicle. Processes for selecting the service provider can include identifying a list of service providers within a service area, and selecting the service provider based at least in part on a distance of the service provider from the user vehicle location. Alternatively, a service provider can be selected based on next availability, or other suitable parameter. Instructions generated for instructing the service provider to conduct the refueling operation can include a location and a time for refueling the user vehicle in response to the user request and based on the vehicle location and requested time, and may include other information, such as a fuel type for the refueling operation, instructions for accessing the user vehicle, and the like. According to some embodiments, obtaining access to the user vehicle for conducting the refueling operation can include causing an unlocking mechanism to release a refueling cover in order to provide access to refuel or recharge the user vehicle.

### BRIEF DESCRIPTION OF THE DRAWINGS

Various embodiments in accordance with the present disclosure will be described with reference to the drawings, in which:

FIG. 1 is a high-level block diagram illustrating a system for remotely fueling vehicles, in accordance with various embodiments of the present disclosure;

FIG. 2 is a diagram illustrating an example system for remotely providing fueling access, in accordance with the fueling system of FIG. 1;

FIG. 3 is a communication diagram illustrating a method for enabling requests for remote fueling, in accordance with the fueling system of FIG. 1;

FIG. 4 is a process flow diagram illustrating a first method for enabling remote fueling, in accordance with various embodiments;

FIG. 5 is a process flow diagram illustrating a second method for enabling remote fueling, in accordance with various embodiments;

FIG. 6 is a process flow diagram illustrating a third method for enabling remote fueling, in accordance with various embodiments; and

FIG. 7 is a conceptual graphical user interface diagram illustrating features of a user device interface and an operator device interface.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced in other configurations, or without the specific details. Furthermore, well-known features may be omitted or simplified in order not to obscure the embodiment being described.

In accordance with various embodiments of the present disclosure, systems and methods for remotely fueling vehicles include a service that can communicate with customer devices (e.g. a downloadable smartphone application, computer, or web supported application), with operator or agent devices for facilitating remote refueling, and with a scheduling service that performs mapping, route finding, and scheduling functions. Each customer device can be registered for one or for multiple passenger vehicles, and a customer account associated with each vehicle can include information about the vehicle including fuel type (e.g., gasoline, diesel, electric), fuel grade, fuel capacity, a designated vehicle location, or an instantaneous vehicle location.

In operation, a remote refueling system can facilitate remote refueling of a passenger vehicle by, through communication with the customer device, determining a time and a location for a remote refueling. The system can communicate the determined time, location, and other refueling parameters to a selected operator or agent via the operator/agent device, and can communicate the completion of the remote refueling to the customer via a customer device. The system can coordinate refueling operations for many passenger vehicles by selectively assigning agents to refuel customer vehicles associated with requests based on a number of variables. For example, according to various embodiments, the system can assign an agent to refuel a passenger vehicle based on the availability of the agent, the proximity of the agent to the passenger vehicle, an amount of stored fuel available to the agent, a characteristic of the fuel available to the agent (i.e., whether an agent carries a fuel type of integrated required for the passenger vehicle), or other suitable consideration.

According to various embodiments, the system can accommodate potentially large numbers of passenger vehicles by coordinating the operation of a fleet of agents over any given service region. In addition, according to various embodiments, the system can also predict future availability of an agent based on the projected fuel requirements of any number passenger vehicles scheduled for remote refueling by the agent, capacity information of those passenger vehicles, historical information about the fuel requirements of passenger vehicles, proximity to a refueling station or a projected requirement for refueling, fuel capacity of the agent, and other suitable considerations.

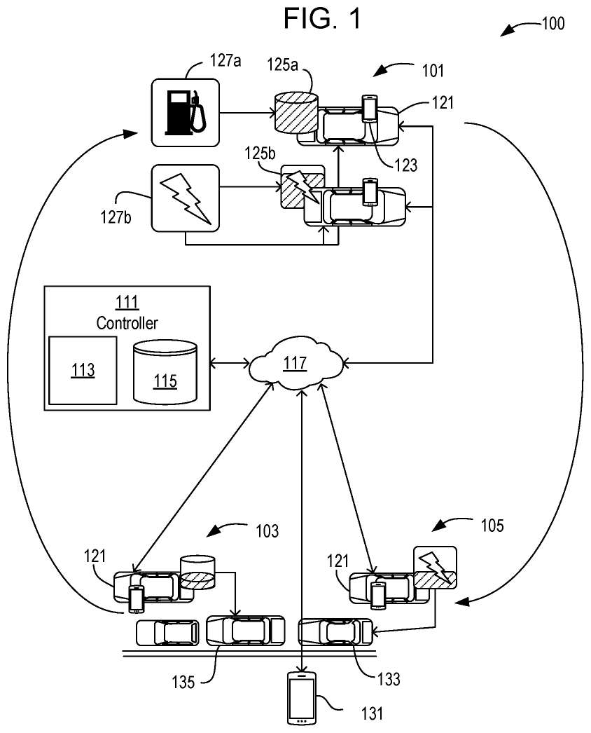

Turning now to the figures, FIG. 1 is a high-level block diagram illustrating a system 100 for remotely fueling vehicles, in accordance with various embodiments of the present disclosure. The system 100 can include a controller 111 including at least one processor 113 and a nontransitory memory device 115 storing executable instructions that, when executed by the processor, cause the controller to manage the operation of the system 100 by communicating information and instructions with any suitable number of service provider devices 123 and with any suitable number of user devices 131. The system 100 operates by the controller 111 scheduling the transportation of fuel or stored electricity by any suitable number of service providers 121, who are decentralized and mobile, to refuel parked vehicles of customers/users 133, 135 upon request, via a network 117, such as a wireless or cellular network. The controller 111 can coordinate scheduling and/or route-finding to direct a service provider 121 to supply or resupply 101, and then to provide refueling services 103 or recharging services 105, or both.

According to various embodiments, upon receipt of a request from a user device 131, the controller 111 process the request and selects an appropriate service provider from a list of available service providers in a vicinity of the user's vehicle 133 or 135. Selecting an appropriate service provider can include identifying a number of service providers that are active within a range of the requesting user device 131, and narrowing the list of service providers to service providers capable of meeting the user request. For example, if the user device 131 originating the user request is associated with an internal combustion vehicle 135, a service provider 121 carrying a supply of liquid fuel 125a may be selected. If the user device 131 originating the user request is associated with an electric vehicle 133, a service provider 121 equipped with a rapid charger 125b may be selected.

Service providers 121 can operate independently, with a centralized controller 111 coordinating a schedule for each service provider to provide refueling services to users that may be distributed throughout a service area. Service providers 121 can be directed by the controller 111 to provide refueling services to any suitable number of user vehicles 133, 135 according to a fuel demand of those vehicles and a capacity of the fuel storage for each service provider. When a service provider 121 has exhausted their reserve of fuel, the controller 111 can schedule a resupply stop and direct the service provider to visit a service station to refuel the service provider vehicle, and to resupply the service provider fuel supply. Service provider vehicles can be either internal combustion vehicles or electric vehicles, but are preferably electric vehicles. Service provider vehicles can include a fleet of both liquid fuel-carrying vehicles and vehicles with auxiliary battery units and portable rapid charging stations equipped to provide on-demand rapid electric charging for users' electric vehicles. According to some embodiments, resupplying a service provider 121 can include refilling a liquid fuel tank 125a from a liquid fuel supply 127a and simultaneously or subsequently recharging the service provider vehicle from a rapid charging station 127b. According to some other embodiments, resupplying a service provider 121 can include recharging the service provider vehicle and also recharging a portable battery unit 125b from a rapid charging station 127b. Alternatively, resupplying a service provider 121 can include recharging the service provider vehicle and swapping out and exhausted portable battery unit 125b for a charged portable battery unit, particularly in cases where the portable battery units have high capacity to permit multiple recharging operations. In all of the cases described above, a service provider 121 can instead be refueled with a liquid fuel rather than recharged. According to various embodiments, the service provider 121 can operate a service provider vehicle selected from any suitable, commercial or personal electric vehicle, modified to include an auxiliary fuel tank 125a or auxiliary battery unit 125b, which may be mounted in place of a vehicle trunk, passenger compartment, roof-mounted, or otherwise positioned, in line with any local rules, laws, or safety requirements. According to some embodiments, the service provider vehicle can be any suitable, commercial or personal truck or light truck, which can be an electric vehicle, modified to include an auxiliary fuel tank 125a or auxiliary battery unit 125b, which may be mounted as described above, or in a truck bed. Any of the example service provider vehicles described above may be further equipped with, e.g., an automatic fuel pump, or with a rapid charging apparatus. In some embodiments, the service provider vehicle may further include a recharging apparatus for supplementing stored electrical power, either in the auxiliary battery unit 125b for recharging user vehicles, or for recharging the primary battery of the service provider vehicle and supplementing its range, or a combination of both. Recharging apparatuses can include, e.g., regenerative braking devices of the service provider vehicle, solar panels mounted to the service provider vehicle, or the like.

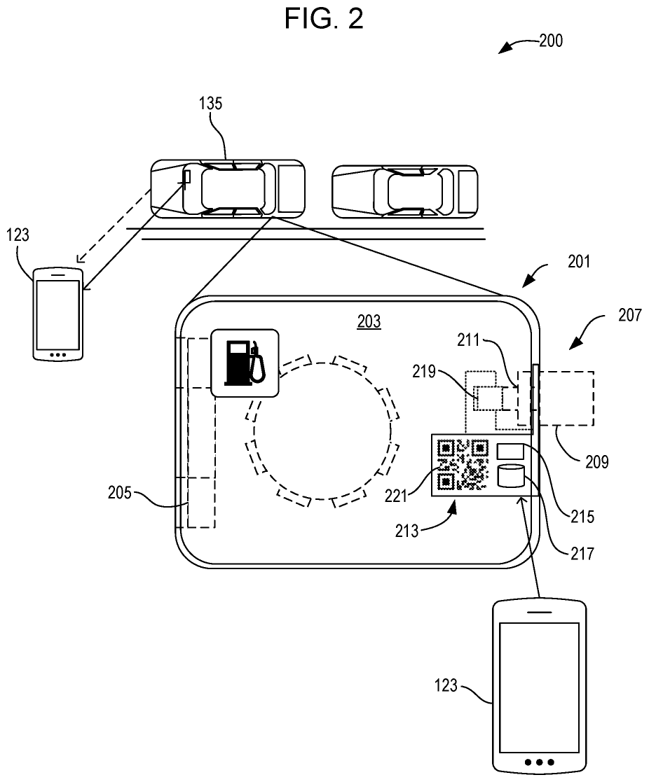

Service providers 121 can locate and identify the vehicle associated with a user request by a variety of methods. For example, according to some embodiments, the user request originating from the user device 131 includes a location (e.g., a GPS pin, an address, or a predesignated site) for the refueling service, as well as information identifying the vehicle. The user request can also relay such information indirectly. For example, according to some embodiments, each user request can originate from a user account that is linked with stored user information including a predetermined location or set of locations registered to the user. In such cases, a user may register an account with the controller 111 with one or more locations, which can be verified or corrected for accessibility prior to the system 100 providing the user with refueling services. Locating the vehicle associated with a user request can include, via the controller 111, directing a service provider 121 to the location associated with the user's vehicle, and providing a description, image, license number, or combination thereof for verification. According to some embodiments, the system 100 can include additional protective features to provide access by the service provider 121 to the fuel compartment or charging port of the user's vehicle, as described below with reference to FIG. 2.

FIG. 2 is a diagram illustrating an example system 200 for remotely providing fueling access, in accordance with the fueling system of FIG. 1. According to various embodiments, the fuel assembly 201 of a passenger vehicle includes a fuel cover 203 that is generally locked to prevent unauthorized access to the fuel tank or charging port. Fuel cover 203 can be secured by a hinge 205 at one end and a locking mechanism 207 at the other end, which typically engages by way of a lock 209 from which extends a locking pin 211 to prevent opening of the cover. A remove unlocking mechanism 213 can be installed on a fuel cover 203 to permit remote access by an authorized service provider. For example, in one embodiment, a remote unlocking mechanism 213 can include an actuator 219 attached with the cover 203 and positioned to depress the locking pin 211 in order to unlock the cover. The actuator 219 can be operably connected with a processor 215 and memory device 217 that cause the actuator to move in response to receiving a signal, e.g., a coded RF signal, wireless signal, acoustic signal, or other suitable signal from a portable device 123. According to some embodiments, the portable device 123 can be a mobile device (e.g., tablet, phone, or handheld device, or other suitable device) carried by the authorized service provider. A machine-readable code or indicia 221 can be attached to the user's vehicle as well, either directly or indirectly, and can be read by the portable device 123 carried by the authorized service provider in order to positively identify the user's vehicle, or to facilitate generating an unlock signal for opening the cover 203. For example, in some embodiments, the portable device 123 can be programmed to generate the unlock signal for opening the cover based in part on information embedded in the indicia 221. The indicia 221 is shown attached with the fuel cover 203 via the unlock mechanism 213, however, the indicia can be placed by a user at any suitable location on the vehicle, such as adhered inside a window, on the dashboard, or attached to the exterior.

Many alternative methods can be used to facilitate secure access by an authorized service provider to refuel or recharge a user's vehicle. For example, according to some embodiments, authorized service providers can maintain a set of encrypted wireless or RF codes associated with the registered users' vehicles, and can access the vehicles using the stored wireless or RF codes temporarily in order to facilitate the refueling operation, and to re-lock the users' vehicles after each refueling operation. And according to some embodiments, users can be prompted by the system 100 (FIG. 1) to unlatch the fuel compartment or charging port of their vehicles before the service window.

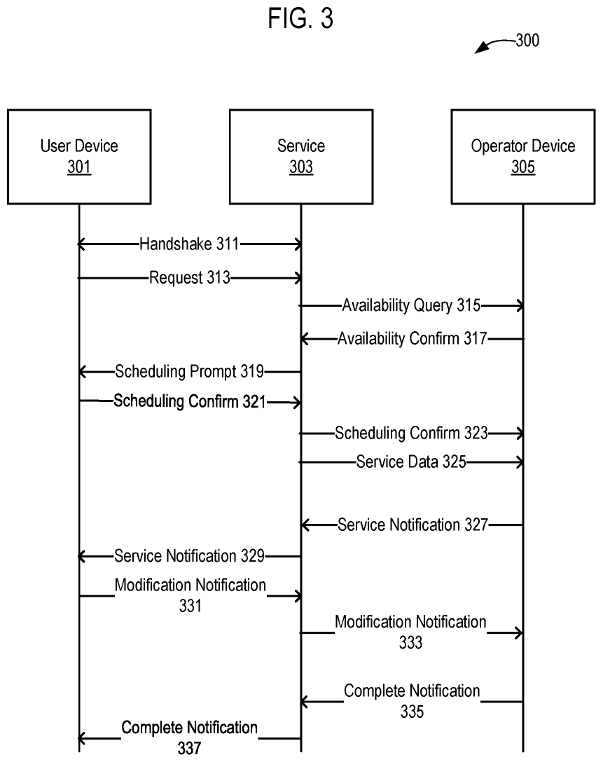

FIG. 3 is a communication diagram illustrating a method 300 for enabling requests for remote fueling, in accordance with the fueling system of FIG. 1. According to various embodiments, the communication method 300 includes stages of communication between a user device 301, a service 303 (e.g., managed by controller 111, or a distributed service provider), and an operator or service-provider device 305. It will be understood that, implemented, the steps described below may occur in a different order, may include additional communication steps or omit communication steps, and that potentially many user devices 301 can communicate with the service 303 at the same time, and likewise that many operator devices 305 can communicate simultaneously with the service 303 as well. Each individual service request is initiated by a user request from user device, in which the user device 301 initiates a handshake 311 with the service 303 to confirm the identify or account associated with the user device. The user device can then transmit the request 313, which can include information about the location of the user vehicle, the fuel type, the amount of fuel or charge requested, a service window requested, or other suitable information. The service 303 can then initiate an availability query 315 of any network-connected operator devices that are eligible for handling the user request.

When availability confirmation 317 has been received from an eligible operator device, the service 303 can provide a scheduling prompt 319 to the user device. The scheduling prompt may include a request to confirm the service appointment at the requested time and location. Alternatively, the scheduling prompt can include alternative, or additional information about the available service appointment times or locations. For example, in some embodiments, if the user device provided a schedule window, the scheduling prompt 319 may include a specific estimated time of arrival, or a range of arrival times. If the user device provided a specific requested time, the scheduling prompt 319 may provide a nearest available time or time window. If the time(s) requested in the user request are not available, the scheduling prompt 319 can include a suggested alternative time or time window. Likewise, if the location designated by the user device is not locatable, the scheduling prompt 319 can include alternative location information, or can request that the user submit a new request.

Following the scheduling prompt 319, the user device can request that the user provide scheduling confirmation 321. When the service 303 confirms that the user has agreed, the service can provide a scheduling confirmation to the operator device 305, which may prompt the operator device to add the service stop to its schedule, and may change stored availability information of the service provider to indicate that the provider is no longer available during a selected time window. The service 303 can also submit service data 325 to the operator device to assist in locating and providing the service requested by the user.

Prior to the service time, the operator device 305 can provide a service notification 327 to the service 303, either to indicate that the service provider is en route on schedule, or to indicate a delay or other exception. The service 303 can relay the service notification 329 to the user device, which in some cases may prompt the user to approve or decline a modification of the service. For example, if the user changes their mind about completing the refueling service, the user can input a cancellation, which can be relayed by the user device 301 to the service 303 as a modification notification 331, and then relayed as a modification notification 333 to the operator device in order to clear the service appointment. Alternatively, the modification notifications 331, 333 may indicate approval to continue the service appointment, a change in the service parameters (e.g., changed location, changed time), or other change in the service request.

Upon completion of the service appointment, the service provider may input a command on the operator device 305 indicating that the service has been successfully completed, which can be transmitted to the service 303 as a complete notification 335. The complete notification 335 can include additional information, such the amount of fuel and type used to complete the service request, the mileage to travel to the refuel location, the user's compliance with requested parking parameters (e.g., was the user's vehicle easy to located and identify, was the fuel cover easy to access, etc.), and other information. The service 303 can provide a final complete notification 337 to the user via the user device 301, which can include a notification that the service has been completed, a summary of the service that was completed, an invoice for the completed service, or a receipt following the processing of payment from stored account information for the completed service.

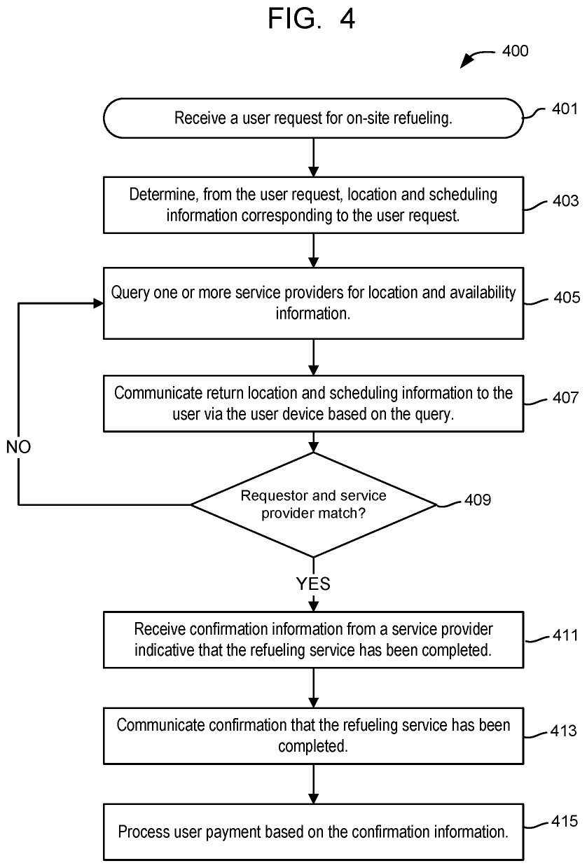

Various methods for implementing the approaches to on-site refueling of passenger vehicles are described in detail below with reference to FIG. 4-6. Some or all of the processes 400, 500, and 600 described below (or any other processes described herein, or variations, and/or combinations thereof (may be performed under the control of one or more computer systems configured with executable instructions and may be limited as code (e.g., executable instructions, one or more computer programs, or one or more applications) executing collectively on one or more processors, by hardware or combinations thereof. The code may be stored on a computer-readable storage medium, for example, in the form of a computer program comprising a plurality of instructions executable by one or more processors. The computer-readable storage medium may be non-transitory. In various embodiments, the processes or combinations thereof may be carried out by, for example, a local controller such as a client device, a service provider device, or a network enabled centralized controller in communication via the network with any number of client devices and service provider devices.

FIG. 4 is a process flow diagram illustrating a first example method 400 for enabling remote fueling, in accordance with various embodiments. At 401, a mobile refueling control system can receive a user request for on-site mobile refueling, e.g., from a network-connected user device operating a software application. The user request can include information for coordinating an on-site refueling operation, such as but not limited to a location for the refueling request and a time or time window for the request. According to various embodiments, the user request can include additional information about the target vehicle for mobile on-site refueling, such as but not limited to information about the vehicle (e.g., make, model, license plate, color), identifying information associated with the user (e.g., information corresponding to a machine-readable code connected with the vehicle, access information for accessing the vehicle, the fuel tank, or a charging port, refueling information (e.g., fuel type, fuel tank or battery capacity, fuel amount requested), or other refueling information. In some embodiments, information associated with the vehicle or with the user can be stored in a database associated with a customer account, which can be communicated to a service provider or can be requested by a service provider in response to the receipt of the user request.

At 403, the control system can determine, from the user request and/or from stored user information, a location and scheduling information corresponding to the user request. The location and scheduling information can include an address or coordinate at which the user vehicle can be located at the requested refueling time. According to some embodiments, location information can be obtained based on a real-time location of a user device at the time of the request, or a location selected by the user at the time of the request. According to various other embodiments, the location can be associated with a user account (i.e., a preapproved address at which access to the vehicle can be verified, such as a home address with residential street parking, residential driveway parking, or accessible garage parking, or a work address with accessible parking lot or garage parking). At 405, the system can obtain service provider information for a list of service providers operating in a vicinity of the location at which user request is pending, and query one or more service providers for location and availability information. According to some embodiments, this can be done on one-by-one basis according to a service provider queue. Alternatively, location and availability information of multiple service providers within a vicinity of the request can be processed simultaneously, or based on a service parameter. For example, in some specific embodiments, service providers can be queried for availability based on a distance from the location of the user request, or based on an availability of the service providers (i.e., next available opening).

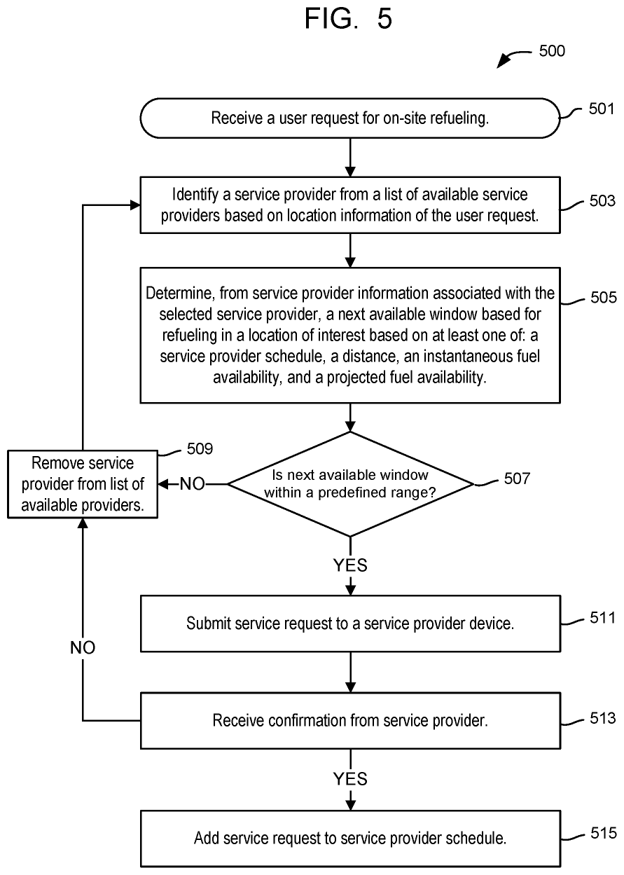

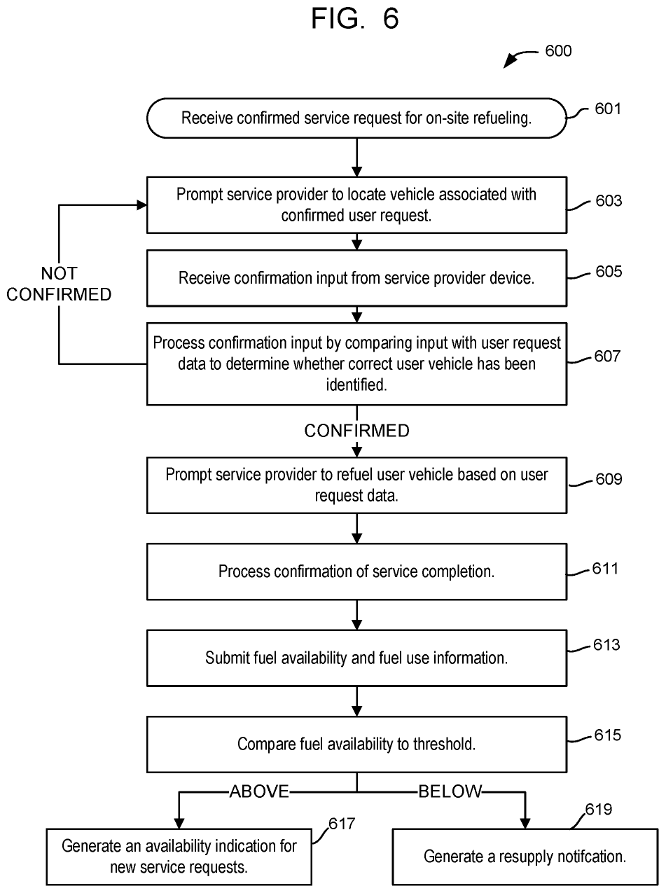

When a service provider has been identified, the system can relay return information to the user device, at 407, indicating the refueling parameters that can be met by the service provider (e.g., fuel type, amount, available time window) for matching with parameters of the request. The service can compare the user request to the return information to determine whether the service provider can fulfill the user request, at 409. The matching determination can be entirely automated based on a determination that the service provider schedule is open during the time or time window requested by the user, that the service provider is within a service distance of the user, and that the service provider has sufficient fuel of the correct type to service the vehicle of the requesting user. Alternatively, the matching determination can depend in part on a query sent to a service provider device to indicate whether the service provider is available. If the user request and the first selected service provider do not match at 409, the system can iteratively query the additional service providers in the vicinity of the user request. If the user request and the service provider match, the system can instruct the service provider to respond to the user request. Specific details of an example matching process are described below with reference to FIG. 5, and specific details of a refuel operation are described below with reference to FIG. 6.

The system can determine that a refueling task is complete at 411 based on a confirmation received from a service provider device indicating that the refueling service has been completed. When confirmation has been received, the system at 413 can communicate completion of the refueling service to the user via a user device. According to some embodiments, receipt of confirmation by the system can include information relevant to payment, such as but not limited to the amount of fuel and cost per unit, the distance traveled by the service provider to conduct the refueling task, any special charges (e.g., access restrictions, demand-based pricing, tolls) applicable to the refueling task. Based on this information, the system can submit a request for user payment to the user via the user device, or if pre-authorized, can process a user payment at 415.

FIG. 5 is a process flow diagram illustrating a second example method 500 for enabling remote fueling, in accordance with various embodiments. First, at 501, a system for controlling remote refueling can receive a user request for an on-site refueling task, as described above with reference to FIG. 4. The system can identify a service provider in a vicinity (i.e., within a geographical region or within a set distance associated with the user) of the user request from a list of available service providers based on the location information included in the user request at 503. The system can then, at 505, determine from service provider information associated with the selected service provider or provided by the service provider, a next available window of time for refueling at the location specified by the user request based on at least one of the following: a service provider schedule, including previously determined time windows for accommodating previously scheduled fueling tasks, a distance between the user-requested location and the location of a previously scheduled fueling task (including resupply), an instantaneous fuel availability of the selected fuel type by the service provider, a projected fuel availability of the service provider based on the number of intervening refueling tasks before an available service window, or other factor. For example, according to some embodiments, the system can sum the expected fuel outlay of the intervening refueling tasks before a requested refueling task and determine whether sufficient fuel will be available to meet the request. Alternatively, the system can automatically schedule resupply tasks when sufficient refueling tasks have been scheduled to reduce the fuel supply below a threshold.

At 507, the system can compare the next available window of the selected service provider for the requested refueling task with the requested refueling task. If there is a match between the range of requested times and the availability of the service provider, the system can proceed to submitting the service request to the service provider device 511. If the system does not identify a suitable match between the user request and the service provider availability, the system can remove the particular service provider from the list of available providers for the user request, at 509, and can iteratively select another service provider from the list of available service providers until a match is found. If the system is unable to identify a service provider to match with the user request, the system can expand the list of service providers by geography, can request that the user submit additional times, or can submit proposed times to the user device that are outside the original user request window. According to various embodiments, at 513, the system can first query the service provider to confirm availability to meet a user request. If a selected service provider does not confirm availability, or confirms in the negative, the system can remove the service provider from the list of available service providers at 509 and identify an alternative service provider. If the service provider does confirm, the system can proceed to add the service request to the service provider schedule at 515, as well as providing confirmation to the user making the user request.

FIG. 6 is a process flow diagram illustrating a third example method 600 for enabling remote fueling, in accordance with various embodiments. First, at 601, a system for controlling remote refueling can receive a user request for an on-site refueling task, as described above with reference to FIG. 4 and FIG. 5, and can select a service provider, confirm, and schedule a service stop to meet the user request according to any suitable method as described above with reference to FIGS. 1-5.

Within a designated service window, at 603, the system can prompt the service provider via a service provider device to locate the vehicle associated with the confirmed user request. Next, at 605, the system can receive confirmation from the service provider device indicative that the service provider is responding to the service request. This confirmation can be communicated to the user in the form of a notification, text message, or other suitable communication. If confirmation is not received within a predetermined period of time, or if a negative confirmation is received, the system can notify the user that service is delayed or cancelled.

When the service provider arrives at the location associated with the vehicle specified by the user request, at 607, the service provider can be prompted to confirm the identity of the user vehicle, e.g., by taking visual data (e.g., scanning a machine readable code, scanning a license plate, or taking image data of the vehicle) which can be compared by the system to stored data in order to confirm that the correct vehicle has been identified. If the vehicle cannot be confirmed, the system can continue to prompt the service provider to identify the user vehicle, or in some cases, can notify the user that the vehicle associated with a service request cannot be located, or can request an update to the request.

If the service provider is able to confirm identification of the user vehicle, at 609, the system can prompt the service provider to refuel the user vehicle according to data in the user request, which can include generating instructions to refuel the vehicle with a particular type of fuel or fuel grade, or to charge the vehicle (if electric), either fully or by a predetermined amount. For example, a user request might include a request of the form, “Monday MM-DD-YY, between 5:00 am and 6:00 am, driveway at address, make and model, license no., gasoline, premium, fully refuel,” or similar, in which case the system can prompt the service provider to fully refuel the identified vehicle at the address with premium gasoline. After completion of the refueling task, at 611, the service provider can confirm completion of the service, which is received and processed by the system. Confirmation can include information about the refueling task in addition to binary confirmation of completion, e.g., the amount and type of fuel dispensed, whether the user vehicle was identified in the correct location, the distance traveled and cost of traveling to the service location, and other suitable information.

According to some embodiments, at 613, the system can review fuel availability and fuel use information of each service provider periodically or after each service task in order to determine whether a service provider's fuel usage is in-line with scheduled fuel use. For example, in some embodiments, this determination can include a comparison of the remaining available fuel transported by a service provider with a predetermined threshold quantity, at 615, typically associated with the required quantity for performing a typical refueling task, or in some cases for performing the next scheduled refueling task. If the amount of remaining fuel is above a threshold, the system can indicate that the service provider is available for new service requests at 617. If the amount of fuel available is below a threshold, the system can notify the service provider that resupply is requested before continuing on a mobile refueling route, or before accepting new refueling tasks, at 619. In some embodiments, the resupply notification can include automatically adding a resupply task to the service provider's refueling schedule.

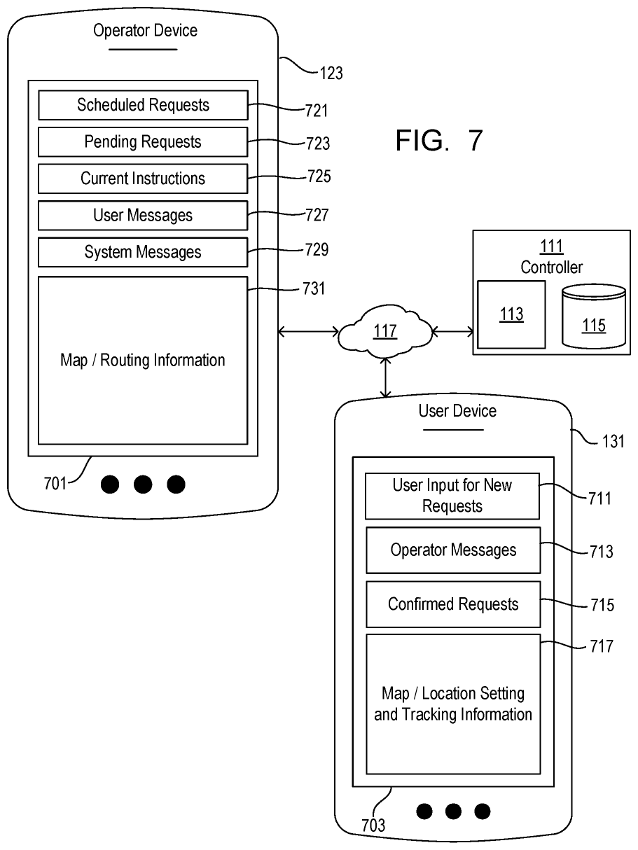

FIG. 7 is a conceptual graphical user interface diagram illustrating features of a user device interface 703 and an operator device interface 701, in accordance with various embodiments of the present disclosure. As discussed above, instructions to generate a service appointment can be generated by a user via a user device 131 and relayed to a controller 111 via a network 117 for processing user inputs in order to schedule a service visit by an operator. The operator can communicate availability information and/or confirm appointments via an operator device 123 in communication with the same controller 111 via the network 117. These “back-end” functions are described above with reference to FIGS. 1-6.

Communication between a user and the controller 111 or the operator via the operator device 123 can be conducted via a user graphical user interface (User GUI) 703. According to at least one embodiment, the user GUI 703 can be a software application that is loaded on to the user device 131 and provides access to data input/output fields. For example, the user GUI 703 can include a first user input field 711 for receiving user input of new requests, including request information (e.g., any suitable combination of location, time, vehicle information, payment information, etc.). The user input field 711 may communicate with a map module 717 to facilitate the selection of a specific location (e.g., via GPS location or similar selector) when a user indicates, via the user input field, that the user intends to select a location for a service appointment. An operator communication field 713 can also be present, and may include a text field for presenting notifications provided by the operator, or provided by the controller 111 on behalf of the operator, e.g., notifications that a service appointment has been scheduled or has been rejected, notifications that the operator is en route to conduct a service, notifications that an operator is running ahead of or behind schedule, and other suitable communications. The operator communication field 713 can also facilitate user communication back to the operator or to the controller 111. This can include, for example, providing pop-up access to a virtual keyboard to facilitate direct communication of text by the user to the operator, providing access to a menu of communication options for the user to communicate to the operator (e.g., an instruction to proceed, an instruction indicating a new vehicle location, an instruction cancelling a service or requesting a reschedule, or other suitable communication). The user GUI 703 can include a confirmed requests field 715 that provides textual information about a confirmed service request, e.g., a time and location of servicing, as well as any suitable parameters of the service that had been requested, and additional concurrently-generated information such as the estimated time of arrival of the service provider. In addition, the user GUI 703 may also present mapping information 717 that, as described above, can be used to designate a service location, and may also be used to track the progress and location of an operator who has been scheduled to conduct a service operation.

Communication between an operator and the controller 111 or between the operator and a user device 131 can be conducted via an operator graphical user interface (Operator GUI) 701. According to at least one embodiment, the operator GUI 701 can be a software application that is loaded on to the operator device 123 and provides access to data input/output fields. For example, the operator GUI 701 can include a scheduled requests field 721 for tracking and displaying scheduled service requests, including request information (e.g., any suitable combination of location, time, and vehicle information) usable by the operator to locate a user vehicle and conduct a service operation. The scheduled requests field 721 may communicate with an operator map module 731 to facilitate the identification of specific vehicle locations, e.g., highlighting a location marker on a map in response to the operator selecting a specific scheduled request. The operator GUI 701 can also provide a pending requests field 723 for displaying requests that have not yet been scheduled, which can include request information (e.g., location, time, time window, etc.) and may prompt the operator to accept or decline pending requests, to suggest or select a time for fulfilling new requests, or to communicate with a requesting user. According to some embodiments, scheduled and pending requests can be listed in the same field, and may be denoted or coded as scheduled and pending.

According to various embodiments, the operator GUI 701 can include any suitable combination of the following additional fields or modules, e.g., a field displaying current-task instructions 725, a field displaying user messages 727, and a field displaying system messages 729. The field displaying current-task instructions 725 may include text instructions that direct the operator to perform the next requisite task in a servicing schedule, such as transiting from a current location to a user vehicle for providing a service, transiting from a current location to a resupply station, or conducting a service procedure. Any one of these steps may be broken down and displayed as a series of steps, such as driving instructions (which may be text only, or may be generated audibly), instructions to locate a user vehicle by description, license plate, or location, or step-by-step instructions to refuel or recharge a user vehicle. The field displaying user messages 727 can include a text field for relaying messages originating from the user device 131, or originating from the controller 111 on behalf of the user based on selections made by the user, such as instructions to delay or cancel an appointment, instructions that a vehicle has moved, specific instructions for locating a vehicle, (e.g., “by the hedge,” or “in the driveway marked 123,”) or the like. In some embodiments, the field for displaying user messages 727 can also facilitate communication from the operator to the user, which may include permitting direct text input by the operator via a virtual keypad, or may be limited to a selection of responses relevant to the task, e.g., “Got it,” “No can do,” “ETA 1:23,” or similar. In addition, the operator GUI 701 may also present mapping information 731 that, as described above, can be used to designate a service location, and may provide route-mapping and guidance for an operator to locate a next service location, resupply stop, or other scheduled task.

The GUIs 701 and 703 and the underlying application provide many technological improvements over conventional systems. For example, in conventional system, a user may use a standalone map application to look up nearby gas stations and/or a phone application to communicate with the nearby gas stations or emergency services, such as a tow truck. An operator at the gas station or at a towing company may at best use a phone application to respond to a call from the user. An emergency service may additionally use a map application or a location triangulation application to find the location of the user. In contrast thereto, the GUI 701 and the underlying application integrates services for the user to facilitate convenient nonemergency or emergency refueling services, where these services would otherwise be segregated along different applications, or might not even available. Likewise, the GUI 703 and the underlying application integrates different services for the operator, where these services would otherwise be segregated along different applications, or might otherwise not be available. In other words, each application enables new computing services that are not available in conventional system, and each GUI enables an intuitive interface to request, use, view, and modify the computing services without the need to navigate between different applications on a same device or the use of multiple devices as in the conventional systems.

Various computational methods discussed above may be performed in conjunction with or using a computer or other processor having hardware, software, and/or firmware. The various method steps may be performed by modules, and the modules may comprise any of a wide variety of digital and/or analog data processing hardware and/or software arranged to perform the method steps described herein. The modules optionally comprising data processing hardware adapted to perform one or more of these steps by having appropriate machine programming code associated therewith, the modules for two or more steps (or portions of two or more steps) being integrated into a single processor board or separated into different processor boards in any of a wide variety of integrated and/or distributed processing architectures. These methods and systems will often employ a tangible media embodying machine-readable code with instructions for performing the method steps described above. Suitable tangible media may comprise a memory (including a volatile memory and/or a non-volatile memory), a storage media (such as a magnetic recording on a floppy disk, a hard disk, a tape, or the like; on an optical memory such as a CD, a CD-R/W, a CD-ROM, a DVD, or the like; or any other digital or analog storage media), or the like.

The particulars shown herein are by way of example and for purposes of illustrative discussion of the preferred embodiments of the present invention only and are presented in the cause of providing what is believed to be the most useful and readily understood description of the principles and conceptual aspects of various embodiments of the invention. In this regard, no attempt is made to show structural details of the invention in more detail than is necessary for the fundamental understanding of the invention, the description taken with the drawings and/or examples making apparent to those skilled in the art how the several forms of the invention may be embodied in practice.

The following definitions and explanations are meant and intended to be controlling in any future construction unless clearly and unambiguously modified in the following examples or when application of the meaning renders any construction meaningless or essentially meaningless. In cases where the construction of the term would render it meaningless or essentially meaningless, the definition should be taken from Webster's Dictionary, 3rd Edition or a dictionary known to those of skill in the art, such as the Oxford Dictionary of Biochemistry and Molecular Biology (Ed. Anthony Smith, Oxford University Press, Oxford, 2004).

Unless the context clearly requires otherwise, throughout the description and the claims, the words ‘comprise’, ‘comprising’, and the like are to be construed in an inclusive sense as opposed to an exclusive or exhaustive sense; that is to say, in the sense of “including, but not limited to”. Words using the singular or plural number also include the plural and singular number, respectively. Additionally, the words “herein,” “above,” and “below” and words of similar import, when used in this application, shall refer to this application as a whole and not to any particular portions of the application.

The description of embodiments of the disclosure is not intended to be exhaustive or to limit the disclosure to the precise form disclosed. While the specific embodiments of, and examples for, the disclosure are described herein for illustrative purposes, various equivalent modifications are possible within the scope of the disclosure, as those skilled in the relevant art will recognize.

All references, including patent filings (including patents, patent applications, and patent publications), scientific journals, books, treatises, technical references, and other publications and materials discussed in this application, are incorporated herein by reference in their entirety for all purposes.

Aspects of the disclosure can be modified, if necessary, to employ the systems, functions, and concepts of the above references and application to provide yet further embodiments of the disclosure. These and other changes can be made to the disclosure in light of the detailed description.

Specific elements of any foregoing embodiments can be combined or substituted for elements in other embodiments. Furthermore, while advantages associated with certain embodiments of the disclosure have been described in the context of these embodiments, other embodiments may also exhibit such advantages, and not all embodiments need necessarily exhibit such advantages to fall within the scope of the disclosure.

While the above provides a full and complete disclosure of exemplary embodiments of the present invention, various modifications, alternate constructions and equivalents may be employed as desired. Consequently, although the embodiments have been described in some detail, by way of example and for clarity of understanding, a variety of modifications, changes, and adaptations will be obvious to those of skill in the art. Accordingly, the above description and illustrations should not be construed as limiting the invention, which can be defined by the appended claims.

Other variations are within the spirit of the present disclosure. Thus, while the disclosed techniques are susceptible to various modifications and alternative constructions, certain illustrated embodiments thereof are shown in the drawings and have been described above in detail. It should be understood, however, that there is no intention to limit the disclosure to the specific form or forms disclosed, but on the contrary, the intention is to cover all modifications, alternative constructions and equivalents falling within the spirit and scope of the disclosure, as defined in the appended claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the disclosure and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is intended to be understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Preferred embodiments of this disclosure are described herein, including the best mode known to the inventors for carrying out the disclosure. Variations of those preferred embodiments may become apparent to those of ordinary skill in the art upon reading the foregoing description. The inventors expect skilled artisans to employ such variations as appropriate and the inventors intend for the disclosure to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

All references, including publications, patent applications and patents, cited herein are hereby incorporated by reference to the same extent as if each reference were individually and specifically indicated to be incorporated by reference and were set forth in its entirety herein.

What is claimed is:

1. A system for on-demand vehicle refueling, comprising:
a user graphical user interface (User GUI) configured to operate on a user device and display information to and receive commands from a user;
an operator graphical user interface (Operator GUI) configured to operate on an operator device and display information to and receive commands from a service provider; and
a controller comprising at least one processor and a memory device containing executable instructions that, when executed by the at least one processor, cause the controller to:
receive a service request from a user device in response to receipt of a user command by the user GUI, the service request comprising a request location and request timing information for a refueling operation;
generate a service appointment for presentation to the service provider via the operator GUI, the service appointment comprising a service location and service timing information based at least in part on the request location and request timing information;
receive a service completion notification from the operator device; and
communicate, to the user via the user GUI, that the service request has been completed in response to receiving the service completion notification.

2. The system of claim 1, wherein the user device and the operator device comprise mobile devices operably connected with the controller via a network.

3. The system of claim 1, wherein the executable instructions further cause the controller to:
access stored vehicle identifying information om response to receiving the service request; and
communicate, to the service provider via the operator device, the vehicle identifying information.

4. The system of claim 1, wherein the executable instructions further cause the controller to:
receive supply information from the operator device indicative of a quantity of fuel or energy carried by the service provider;
generate a resupply instruction for presentation to the service provider in response to a determination that the quantity of fuel or energy has fallen below a threshold; and
communicate, to the service provider via the operator device, the resupply instruction.

5. The system of claim 1, wherein:
the executable instructions further cause the controller to generate a schedule comprising one or more service appointments and one or more transit periods between the service appointments based on distances between the service appointments; and
generating the service appointment comprises adding the service appointment and a transit period to the schedule.

6. The system of claim 1, wherein the executable instructions further cause the controller to:
receive service information from the operator device indicative of an amount of fuel or energy delivered; and
process a user payment based on the received service information in response to receiving the service completion notification.

7. A method for on-demand vehicle refueling, comprising:
receiving, by a computer system, a user request originating from a user GUI operating on a user device to refuel a user vehicle, the user request including at least a user vehicle location and a requested time;
selecting a service provider based at least in part on a distance of the service provider from the user vehicle location;
generating an instruction for presentation to the selected service provider via a service provider GUI operating on an operator device, the instruction indicating at least a location and a time for refueling the user vehicle in response to the user request and based on the vehicle location and requested time.

8. The method of claim 7, wherein selecting the service provider comprises:
identifying a list of service providers within a service area associated with the user vehicle location; and
selecting the service provider from the list of service providers based on an availability of the service provider at the requested time.

9. The method of claim 7, wherein selecting the service provider comprises:
identifying a list of service providers that are available at the requested time; and
selecting the service provider from the list of service providers available at the requested time.

10. The method of claim 7, wherein:
the user request includes fuel requirement information associated with the user vehicle; and
selecting the service provider comprises identifying a list of service providers carrying a compatible fuel based on the fuel requirement information, and selecting the service provider from the list of service providers.

11. The method of claim 7, wherein:
the user request includes fuel demand information associated with the user vehicle; and
selecting the service provider comprises identifying a list of service providers carrying a sufficient quantity of fuel based on the fuel demand information.

12. The method of claim 7, further comprising:
receiving fuel supply information from the service provider indicative of an amount of fuel carried by the selected service provider;
comparing the amount of fuel to a threshold; and
generating an instruction for presentation to the selected service provider instructing the service provider to resupply in response to the amount of fuel falling below the threshold.

13. The method of claim 7, further comprising:
scheduling the instruction for presentation to the selected service provider based in part on the requested time, a previous scheduled refueling time, and a distance between the user vehicle location and a previous scheduled refueling location.

14. The method of claim 7, further comprising:
retrieving, from a data store, user information associated with the user vehicle in response to receiving the user request; and
generating a notification for presentation to the selected service provider that includes the user information.

15. The method of claim 7, further comprising:
receiving an indication from the service provider that the user request has been fulfilled; and
generating a notification for presentation to the user indicative that the user request has been fulfilled.

16. The method of claim 7, further comprising:
receiving vehicle identifying information from the service provider;
comparing the received vehicle identifying information with stored user vehicle information; and
determining, based on the comparing, whether the vehicle identifying information corresponds to the user vehicle.

17. The method of claim 7, further comprising:
causing an unlocking mechanism connected with the user vehicle to actuate in order to release a refueling cover to permit access by the service provider to refuel or recharge the user vehicle.

18. A system for on-demand vehicle refueling, comprising:
a user graphical user interface (User GUI) configured to operate on a user device and display information to and receive commands from a user;
an operator graphical user interface (Operator GUI) configured to operate on an operator device and display information to and receive commands from a service provider; and
an operator vehicle comprising at least one of a supply tank and a storage battery configured for refueling or recharging another vehicle; and
a controller comprising at least one processor and a memory device containing executable instructions that, when executed by the at least one processor, cause the controller to:
receive a service request from a user device in response to receipt of a user command at the user GUI, the service request comprising a request location and request timing information for a refueling operation; and
generate a query for presentation to the service provider via the operator GUI at the operator device, the query requesting the refueling operation, in response to receiving the service request.

19. The system of claim 18, wherein the executable instructions further cause the controller to:
receive one of an affirmative response or a negative response from the service provider via the operator device;
in response to receiving the affirmative response, generate a service appointment for presentation to the service provider, the service appointment comprising a service location and service timing information based at least in part on the request location and request timing information; and
in response to receiving the negative response, generate a second query for presentation to a second service provider based on the received service request.

20. The system of claim 18, further comprising:
a refueling cover unlocking mechanism attached to a user vehicle configured to permit access by the service provider to refuel or recharge the vehicle.
